(19) United States
(12) Patent Application Publication
(10) Pub. No.: US 2026/0085215 A1
(43) Pub. Date: Mar. 26, 2026

(54) HIGH VISCOSITY ACRYLIC ADHESIVE

(71) Applicant: Dongguan Boxiang Electronic Materials Co., Ltd., Dongguan (CN)

(72) Inventors: Xiaoyang Chen, Nanchong (CN); Rong Chen, Nanchong (CN); Qing Zheng, Ziyang (CN)

(21) Appl. No.: 19/174,710

(22) Filed: Apr. 9, 2025

(30) Foreign Application Priority Data
Sep. 23, 2024 (CN) 202411327109.6

(51) Int. Cl. C09J 133/08; C08F 2/38; C08F 220/06; C08F 220/14; C08F 220/18; C08F 220/32; C08F 230/08; C09J 133/10

(52) U.S. Cl. CPC C09J 133/08; C08F 2/38; C08F 220/06; C08F 220/14; C08F 220/1808; C08F 220/325; C08F 230/085; C09J 133/10; C09J 2433/00

(57) ABSTRACT

A high viscosity acrylic adhesive is provided, which is composed of acrylic resin polymer as a raw material, mixed with a defoaming agent, an anti-aging agent, etc. By preparing a cross-linked modified monomer containing multiple unsaturated vinyl substituents for acrylic resin polymer, a cross-linked network-like structure of acrylic resin polymer can be obtained. The cross-linked structure of acrylic resin polymer has higher internal stress and can exhibit better bonding performance. The cross-linked modified monomer structure contains many ether bonds generated by cycloaddition reaction, which can form hydrogen bonds with a substrate to enhance the bonding performance of the adhesive. The increase in crosslinking density can hinder the movement of the molecular chains of acrylic resin itself, and the rigid benzene ring structure and high bond energy silicon oxygen bonds in the crosslinked modified monomer structure can synergistically enhance the high-temperature resistance of the adhesive.

### CROSS-REFERENCE TO RELATED APPLICATIONS

This application claims priority to Chinese Patent Application No. 202411327109.6, filed on Sep. 23, 2024, which is hereby incorporated by reference in its entirety.

### TECHNICAL FIELD

The present disclosure relates to the field of adhesive technologies, and in particular, to a high viscosity acrylic adhesive for new energy vehicles.

### BACKGROUND

With a global emphasis on environmental protection and sustainable development, new energy vehicles, as a future direction of the automotive industry, are gradually occupying an important position in the market. With rapid development of the new energy vehicle industry, requirements for material performance are also increasing. Adhesives, as one of key materials for connection and sealing, play a crucial role in the manufacturing process of new energy vehicles.

At present, the adhesives used in new energy vehicles mainly include epoxy adhesives and acrylic resin adhesives. Although epoxy adhesives have excellent bonding performance, their cured adhesive hardness is too high and internal stress is too high, which easily pulls off solder pads and other components, thus having a negative impact on the quality of new energy vehicles. Acrylic adhesives can firmly bond various materials, including metals, plastics, glass, etc., with good weather resistance and chemical corrosion resistance, and can maintain stable bonding performance in these harsh environments. Therefore, they have been widely used in the manufacturing of new energy vehicles. However, new energy vehicles will face various complex environmental conditions such as high temperature during use, which requires acrylic resin adhesives to have good high-temperature resistance and maintain high viscosity. However, the heat resistance of acrylic resin adhesives is relatively limited, and there are also defects in practical applications. Therefore, it is of great significance to prepare acrylic resin adhesives with high viscosity and excellent high-temperature resistance.

### SUMMARY

In response to the shortcomings of existing technology, the present disclosure provides a high viscosity acrylic adhesive for new energy vehicles.

A high viscosity acrylic adhesive, which is made from raw materials including the following parts by mass:
36-42 parts of acrylic resin polymer;
1-1.5 parts of defoaming agent;
1-2 parts of anti-aging agent; and
3-6 parts of reinforcing agent.

In some embodiments of the present disclosure, a preparation method of the high viscosity acrylic adhesive includes the following steps:
step 1: weighing each raw material according to ratio for later use;
step 2: adding the acrylic resin polymer, anti-aging agent, and reinforcing agent into a high-speed mixer, mixing mechanically at a stirring rate of 1000-2000 r/min for 10-30 minutes, then adjusting the stirring rate to 200-300 r/min, then adding the defoaming agent and stirring for 10-20 minutes, stopping stirring, letting it stand for 1-2 hours, and discharging to obtain the high viscosity acrylic adhesive.

In some embodiments of the present disclosure, a preparation method of the acrylic resin polymer is as follows:
adding methacrylic acid, methyl acrylate, 2-ethylhexyl acrylate, glycidyl methacrylate, and purified water to a reaction vessel, stirring under a protection with nitrogen gas to form a uniform reaction solution, and then adding azodiisobutyronitrile to the reaction vessel, after adding, controlling a temperature at 78-83° C. and keeping it for 1-2 hours; then adding a cross-linked modified monomer to the reaction vessel; after adding, keeping it warm for 8-12 hours, stopping heating, removing the nitrogen gas, cooling down and discharging, and obtaining the acrylic resin polymer.

In some embodiments of the present disclosure, a mass ratio of methacrylic acid, methyl acrylate, 2-ethylhexyl acrylate, glycidyl methacrylate, azodiisobutyronitrile, and cross-linked modified monomer is 25-28:3-6:1-2:1-3:0.1-0.4:1-2.5.

In some embodiments of the present disclosure, a preparation method of the cross-linked modified monomer is as follows:
adding 1-(acryloyloxy)-3-(methacryloyloxy)-2-propanol, bis[[dimethyl-[3-(oxiran-2-ylmethoxy)propyl]silyl]oxy]-methyl-phenylsilane, and N,N-dimethylformamide to a reaction vessel, stirring to form a uniform reaction solution, then adding a phase transfer catalyst to the reaction solution; after adding, gradually raising a temperature to 60-70° C., keeping it at constant and stirring for 2-4 hours, spinning evaporate to remove solvent, cooling down and discharging, then preparing the cross-linked modified monomer.

In some embodiments of the present disclosure, a molar ratio of 1-(acryloyloxy)-3-(methacryloyloxy)-2-propanol and bis[[dimethyl-[3-(oxiran-2-ylmethoxy)propyl]silyl]oxy]-methyl-phenylsilane is 1:1-2.

In some embodiments of the present disclosure, the phase transfer catalyst is boron trifluoride ether complex.

In the above technical solution, 1-(acryloyloxy)-3-(methacryloyloxy)-2-propanol andis[[dimethyl-[3-(oxiran-2-ylmethoxy)propyl]silyl]oxy]-methyl-phenylsilane are used as raw materials, the principle of cycloaddition reaction between the active substituted hydroxyl and epoxy groups can be utilized under the catalysis of phase transfer catalyst, and by controlling the mass ratio of the two, the cross-linked modified monomer containing multiple active unsaturated vinyl substituents in the structure can be prepared.

In some embodiments of the present disclosure, the defoaming agent is at least one of polyether modified polysiloxanes defoaming agent, polysiloxane defoaming agent, polyether modified polysiloxanes defoaming agent, mineral oil-based defoaming agent or polysiloxane defoaming agent.

In some embodiments of the present disclosure, the anti-aging agent is butylated hydroxytoluene or N-(1,3-dimethylbutyl)-N′-phenyl-p-phenylenediamine.

In some embodiments of the present disclosure, the reinforcing agent is at least one of polyether rubber, chlorohydrin rubber, chloroprene rubber, nitrile rubber or butadiene styrene rubber.

The present disclosure prepares the cross-linked modified monomer containing multiple active unsaturated vinyl substituents in the structure, and the cross-linked modified monomer is crosslinked and polymerized with other monomers of the acrylic resin to obtain the cross-linked network like structure of the acrylic resin polymer. Firstly, the internal stress of the cross-linked structure of the acrylic resin polymer is greater, which can exhibit better bonding performance and have a good positive effect on improving the bonding strength of the adhesive. Besides that, the cross-linked modified monomer structure contains many ether bonds generated by cycloaddition reactions, which can generate hydrogen bonds with a substrate to further enhance the bonding performance of the adhesive. Furthermore, the increase in crosslinking density can hinder the movement of the molecular chains of acrylic resin itself, and the rigid benzene ring structure and high bond energy silicon oxygen bonds in the cross-linked modified monomer structure can synergistically enhance the high-temperature resistance of the adhesive.

### BRIEF DESCRIPTION OF DRAWINGS

In order to more clearly illustrate the technical solution of the embodiments of the present disclosure, a brief introduction will be given to the accompanying drawings required for the description of the embodiments. It is obvious that the accompanying drawings described below are only some embodiments of the present disclosure. For those skilled in the art, other drawings can be obtained based on these drawings without creative work.

FIG. 1 shows an infrared analysis test image of a cross-linked modified monomer.

### DESCRIPTION OF EMBODIMENTS

For the convenience of understanding the present disclosure, a more comprehensive description of the present disclosure will be provided below. The following description shows preferred embodiments of the present disclosure. However, the present disclosure can be implemented in many different forms and is not limited to the embodiments described herein. On the contrary, the purpose of providing these embodiments is to render the understanding of the specification of the present disclosure more thorough and comprehensive.

### Preparation Example 1

### Preparation of Acrylic Resin Polymer

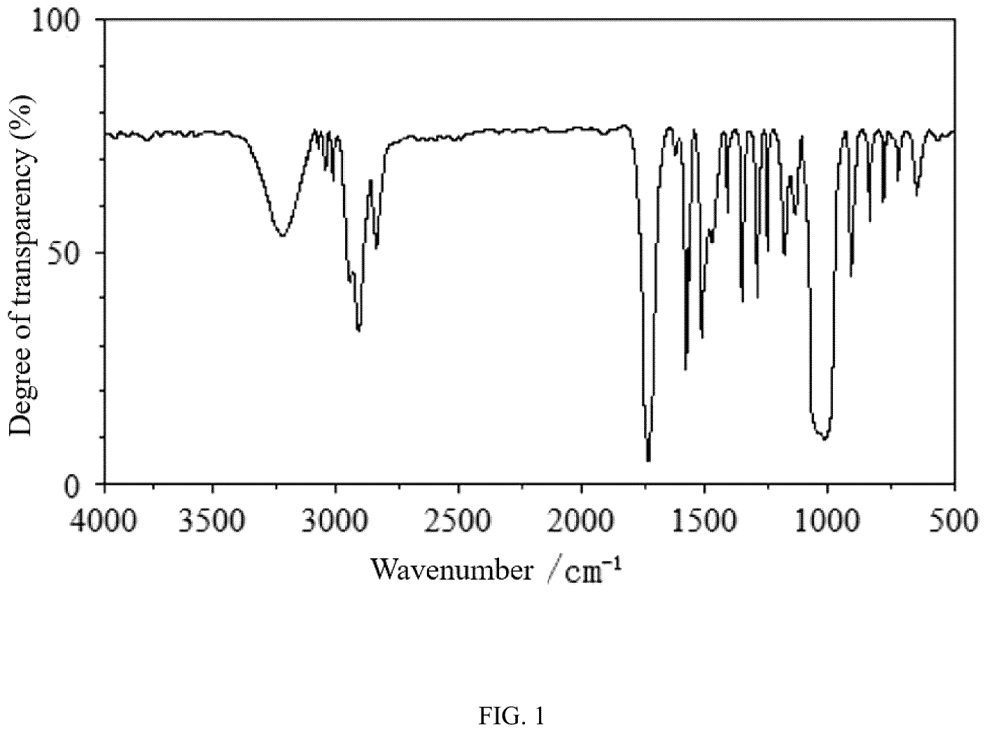

Step 1: adding 0.2 g of 1-(acryloyloxy)-3-(methacryloyloxy)-2-propanol, 0.9 g of bis[[dimethyl-[3-(oxiran-2-ylmethoxy)propyl]silyl]oxy]-methyl-phenylsilane, and N,N-dimethylformamide to a reaction vessel, stirring to form a uniform reaction solution, then adding 0.01 g of boron trifluoride ether complex to the reaction solution; after adding, gradually raising a temperature to 65° C., keeping it at constant and stirring for 3 hours, spinning evaporate to remove solvent, cooling down and discharging, and obtaining the cross-linked modified monomer;
an infrared analysis test was conducted on the cross-linked modified monomer, and results were shown in FIG. 1; an absorption peak at 3239 cm⁻¹ is the hydroxyl characteristic absorption peak generated by the cycloaddition reaction, absorption peaks at 3094 cm⁻¹ and 3072 cm⁻¹ are the carbon hydrogen characteristic absorption peaks of the benzene ring skeleton, an absorption peak at 3025 cm⁻¹ is the carbon hydrogen characteristic absorption peak of the carbon-carbon double bond, an absorption peak at 1746 cm⁻¹ is the carbon-oxygen double bond characteristic absorption peak of the ester group, and absorption peaks at 1000-1100 cm⁻¹ are the characteristic absorption peaks of the overlapping ether bonds and silicon oxygen bond;
step 2: adding 2.6 g of methacrylic acid, 0.35 g of methyl acrylate, 0.2 g of 2-ethylhexyl acrylate, 0.2 g of glycidyl methacrylate, and 50 mL of purified water into a reaction vessel; stirring under a protection with nitrogen gas to form a uniform reaction solution; then adding 0.01 g of azobisisobutyronitrile to the reaction vessel; after adding, controlling a temperature at 82° C. and keeping it for 2 hours; then adding 0.15 g of a cross-linked modified monomer to the reaction vessel; after adding, keeping it warm for 9 hours, stopping heating, removing the nitrogen gas, cooling down and discharging, and obtaining the acrylic resin polymer.

### Example 1

A high viscosity acrylic adhesive for new energy vehicles, which is made from raw materials including the following parts by mass:
36 parts of acrylic resin polymer;
1 part of defoaming agent polyether modified polysiloxanes defoaming agent;
1 part of butylated hydroxytoluene;
3 parts of polyether rubber.

In an implementation mode, a preparation method of the high viscosity acrylic adhesive includes the following steps:
step 1: weighing each raw material according to ratio for later use;
step 2: adding the acrylic resin polymer, butylated hydroxytoluene, and polyether rubber into a high-speed mixer; mixing mechanically at a stirring rate of 1000 r/min for 30 minutes, then adjusting the stirring rate to 200 r/min; then adding polyether modified polysiloxanes defoaming agent and stirring for 10 minutes, stopping stirring, letting it stand for 2 hours, and discharging to obtain the high viscosity acrylic adhesive.

The preparation method of acrylic resin polymer is described in Preparation Example 1, and the following are the same.

### Example 2

A high viscosity acrylic adhesive for new energy vehicles, which is made from raw materials including the following parts by mass:
40 parts of acrylic resin polymer;
1.2 parts of polysiloxane defoaming agent;
1.5 parts of N-(1,3-dimethylbutyl)-N′-phenyl-p-phenylenediamine;
4 parts of chlorohydrin rubber.

In an implementation mode, a preparation method of the high viscosity acrylic adhesive includes the following steps:
step 1: weighing each raw material according to ratio for later use;
step 2: adding the acrylic resin polymer, N-(1,3-dimethylbutyl)-N′-phenyl-p-phenylenediamine, and chlorohydrin rubber into a high-speed mixer; mixing mechanically at a stirring rate of 1500 r/min for 20 minutes, then adjusting the stirring rate to 300 r/min; then adding polysiloxane defoaming agent and stirring for 15 minutes, stopping stirring, letting it stand for 1 hour, and discharging to obtain the high viscosity acrylic adhesive.

### Example 3

A high viscosity acrylic adhesive for new energy vehicles, which is made from raw materials including the following parts by mass:
42 parts of acrylic resin polymer;
1.5 parts of mineral oil-based defoaming agent;
2 parts of butylated hydroxytoluene;
6 parts chloroprene rubber.

In an implementation mode, a preparation method of the high viscosity acrylic adhesive includes the following steps:
step 1: weighing each raw material according to ratio for later use;
step 2: adding the acrylic resin polymer, butylated hydroxytoluene, and chloroprene rubber into a high-speed mixer; mixing mechanically at a stirring rate of 2000 r/min for 10 minutes, then adjusting the stirring rate to 300 r/min; then adding mineral oil-based defoaming agent and stirring for 10 minutes, stopping stirring, letting it stand for 2 hours, and discharging to obtain the high viscosity acrylic adhesive.

### Comparative Example 1

A high viscosity acrylic adhesive for new energy vehicles, which is made from raw materials including the following parts by mass:
40 parts of acrylic resin polymer;
1.2 parts of polysiloxane defoaming agent;
1.5 parts of N-(1,3-dimethylbutyl)-N′-phenyl-p-phenylenediamine;
4 parts of chlorohydrin rubber.

In an implementation mode, a preparation method of the high viscosity acrylic adhesive includes the following steps:
step 1: weighing each raw material according to ratio for later use;
step 2: adding the acrylic resin polymer, N-(1,3-dimethylbutyl)-N′-phenyl-p-phenylenediamine, and chlorohydrin rubber into a high-speed mixer; mixing mechanically at a stirring rate of 1500 r/min for 20 minutes, then adjusting the stirring rate to 300 r/min; then adding polysiloxane defoaming agent and stirring for 15 minutes, stopping stirring, letting it stand for 1 hour, and discharging to obtain the high viscosity acrylic adhesive.

A difference between the preparation method of acrylic resin polymer and Preparation Example 1 is that no cross-linked modified monomer is added.

### Test Example

Referring to national standard GB/T 2791-1995, peel strength tests were conducted on the adhesives in the Examples and Comparative Examples. After the tests were completed, test samples of the same group were placed in an environment of 85° C. and relative humidity of 85% for 1 day, then removed and subjected to peel strength testing again. The results were shown in Table 1:

TABLE 1
Test Results

Peel strength / N/25 mm

| | Initial | After heat treatment |
|---|---|---|
| Example 1 | 12.1 | 11.3 |
| Example 2 | 12.3 | 11.6 |
| Example 3 | 12.0 | 11.3 |
| Comparative Example 1 | 6.9 | 3.5 |

According to the test results in Table 1, it can be concluded that the acrylic resin adhesive prepared using cross-linked modifier as raw material has significantly better bonding performance. However, the adhesive prepared without crosse-linked modifier not only shows a significant decrease in the bonding performance but also has poor high-temperature resistance. This is because the acrylic resin polymer molecular chain prepared without the cross-linked modifier has a straight chain structure, which is easily decomposed when heated, and does not contain rigid benzene rings, silicon oxygen bonds, and ether functional groups, thereby resulting in a significant decrease in overall performance.

Based on the embodiment of the present disclosure, those skilled in the art can make various changes and modifications within the scope of the technical idea of the present disclosure without departing from the above description. The technical scope of the present disclosure is not limited to the specification, and be determined based on the scope of the claims.

What is claimed is:

1. A high viscosity acrylic adhesive, which is made from raw materials comprising the following parts by mass:
36-42 parts of acrylic resin polymer;
1-1.5 parts of defoaming agent;
1-2 parts of anti-aging agent; and
3-6 parts of reinforcing agent.

2. The high viscosity acrylic adhesive according to claim 1, wherein a preparation method of the high viscosity acrylic adhesive comprises the following steps:
step 1: weighing each raw material according to ratio for later use;
step 2: adding the acrylic resin polymer, anti-aging agent, and reinforcing agent into a high-speed mixer, mixing mechanically at a stirring rate of 1000-2000 r/min for 10-30 minutes, then adjusting the stirring rate to 200-300 r/min, then adding the defoaming agent and stirring for 10-20 minutes, stopping stirring, letting it stand for 1-2 hours, and discharging to obtain the high viscosity acrylic adhesive.

3. The high viscosity acrylic adhesive according to claim 1, wherein a preparation method of the acrylic resin polymer is as follows:
adding methacrylic acid, methyl acrylate, 2-ethylhexyl acrylate, glycidyl methacrylate, and purified water to a reaction vessel, stirring under a protection with nitrogen gas to form a uniform reaction solution, and then adding azodiisobutyronitrile to the reaction vessel, after adding, controlling a temperature at 78-83° C. and keeping it for 1-2 hours; then adding a cross-linked modified monomer to the reaction vessel; after adding, keeping it warm for 8-12 hours, stopping heating, removing the nitrogen gas, cooling down and discharging, and obtaining the acrylic resin polymer.

4. The high viscosity acrylic adhesive according to claim 3, wherein a mass ratio of methacrylic acid, methyl acrylate, 2-ethylhexyl acrylate, glycidyl methacrylate, azodiisobutyronitrile, and cross-linked modified monomer is 25-28:3-6:1-2:1-3:0.1-0.4:1-2.5.

5. The high viscosity acrylic adhesive according to claim 3, wherein a preparation method of the cross-linked modified monomer is as follows:
adding 1-(acryloyloxy)-3-(methacryloyloxy)-2-propanol, bis[[dimethyl-[3-(oxiran-2-ylmethoxy)propyl]silyl]oxy]-methyl-phenylsilane, and N,N-dimethylformamide to a reaction vessel, stirring to form a uniform reaction solution, then adding a phase transfer catalyst to the reaction solution; after adding, gradually raising a temperature to 60-70° C., keeping it at constant and stirring for 2-4 hours, spinning evaporate to remove solvent, cooling down and discharging, then preparing the cross-linked modified monomer.

6. The high viscosity acrylic adhesive according to claim 5, wherein a molar ratio of 1-(acryloyloxy)-3-(methacryloyloxy)-2-propanol and bis[[dimethyl-[3-(oxiran-2-ylmethoxy)propyl]silyl]oxy]-methyl-phenylsilane is 1:1-2.

7. The high viscosity acrylic adhesive according to claim 5, wherein the phase transfer catalyst is boron trifluoride ether complex.

8. The high viscosity acrylic adhesive according to claim 1, wherein the defoaming agent is at least one of polyether modified polysiloxanes defoaming agent, polysiloxane defoaming agent, polyether modified polysiloxanes defoaming agent, mineral oil-based defoaming agent or polysiloxane defoaming agent.

9. The high viscosity acrylic adhesive according to claim 1, wherein the anti-aging agent is butylated hydroxytoluene or N-(1,3-dimethylbutyl)-N′-phenyl-p-phenylenediamine.

10. The high viscosity acrylic adhesive according to claim 1, wherein the reinforcing agent is at least one of polyether rubber, chlorohydrin rubber, chloroprene rubber, nitrile rubber or butadiene styrene rubber.
